(19) United States
(12) Patent Application Publication
(10) Pub. No.: US 2008/0057166 A1
(43) Pub. Date: Mar. 6, 2008

(54) Method for extracting highly condensed calcium powder from salted anchovies and the highly condensed calcium powder by obtaining therefrom

(76) Inventors: Mandoe Kim, SaSong-Ku (KR); Steve Kim, Santa Clara, CA (US)

Correspondence Address: WAGNER, MURABITO & HAO LLP;Third Floor, Two North Market Street, San Jose, CA, 95113, US

(21) Appl. No.: 11/652,975

(22) Filed: Jan. 11, 2007

(30) Foreign Application Priority Data
Aug. 31, 2006 (KR) 10-2006-0083097

(51) Int. Cl. A23L 1/00; A23C 1/06; B65B 55/00

(52) U.S. Cl. 426/385; 422/101; 426/390; 426/392; 426/437

(57) ABSTRACT

A method for extracting condensed calcium powder from salted anchovies. According to one embodiment, the organic fish waste (e.g., salted anchovy) is stirred with warm water at a temperature of 70 to 80° C. in a weight ratio of 5:5. In one embodiment, the mixture is deposited into a centrifuge to separate the solid sediments containing anchovy bones and the water phase containing skin, flesh and oily components of anchovies dissolved therein. In one embodiment, a settling and filtration process is used to separate the solid sediments from liquid sediments. The solid sediments are sterilized with steam at a temperature in the range of 150 to 200° C. for 15 minutes. The sterilized solid sediments are dried to remove moisture. In one embodiment, the sterilized solid sediments are pulverized into powder. Optionally, the pulverized powder may be formed into a tablet form and packaged. Accordingly, highly condensed calcium powder is extracted.

### RELATED APPLICATIONS

This application claims the benefit of a Korean application No. 10-2006-0083097, inventors Steve Kim and Mandoe Kim, entitled “METHOD FOR EXTRACTING HIGHLY CONDENSED CALCIUM POWDER FROM SALTED ANCHOVIES AND THE HIGHLY CONDENSED CALCIUM POWDER BY OBTAINING THEREFROM” that was filed on Aug. 31, 2006 with a priority code No. 420040313799 and is incorporated herein in its entirety.

### TECHNICAL FIELD

Embodiments of the present invention relate to production and extraction of Calcium.

### BACKGROUND ART

Salted anchovies are fermented to produce sauce. Generally, the salted anchovies are used for food after fermentation and ripening for 1 to 3 years and the sauce is extracted from the ripened salted anchovies by the pasteurization, sedimentation and filtration, processes. The sediments obtained from the separation of the sauce are dumped or used as animal feed or composts through various treatments.

Conventional calcium formulates or calcium supplements and calcium containing food are mostly made by artificial chemical reactions. Here, ingredients harmful to human bodies may be contained in these products through various processing steps. In order to solve this problems, natural harmless calcium formulates extracted from natural food materials including shellfishes such as oyster shell, seaweeds, milk and the like are developed.

However, it is expensive to buy natural food for extraction of calcium and only the minimum amount of calcium may be extracted as compared to the consumed amount of the natural food material, whereby the selling price is very high because of the rising producer prices. Therefore, small and medium enterprises cannot produce and sell the calcium formulates, calcium supplement food and calcium drugs and the consumers cannot readily use these products due to the high price. Thus, there is a demand for technique to produce highly condensed calcium component by using a small amount of natural food material.

### SUMMARY

Embodiments of the present invention relate to a method for extracting highly condensed calcium powder from salted anchovies and the highly condensed calcium powder obtained therefrom. More particularly, embodiments relate to a method for extracting the calcium component as condensed powder from sediments which would be dumped or be used in preparation of feed stuff for animals by several processes after extraction of the sauce from the salted anchovy and the highly condensed calcium powder obtained therefrom.

Accordingly, it is an object of the present invention to provide a method for extracting highly condensed calcium powder from salted anchovies containing a large amount of calcium by stirring the sediments left after separation of the sauce from the salted anchovies by settling, filtration and centrifugation with warm water, subjecting the mixture to centrifugation to separate the solid phase and liquid phase and sterilizing the solid phase with steam, followed by drying and pulverizing to obtain calcium powder, and to provide the highly condensed calcium powder prepared therefrom.

As described above, according to the method for extracting highly condensed calcium powder from salted anchovies, there is provided highly condensed calcium powder by mixing and stirring the remnants from extraction of the sauce from the salted anchovies (otherwise which would be dumped as waste) with warm water, centrifuging the mixture to separate the liquid phase and the solid phase and sterilizing the solid produce, followed by drying and pulverizing.

Therefore, the calcium powder has a high reliability since it is prepared using natural food material of salted anchovies, not by synthesis of artificial chemical. Also, the producer price is reduced by using remnants, which otherwise would be thrown away, and avoiding the use of artificial chemical reagents, thereby providing high economical efficiency so that the small and medium enterprises can produce and sell. Further, it is possible to provide calcium products at a low price, thereby being helpful to the public health. In addition, the calcium powder according to the present invention contains calcium at a highly condensed level, whereby it is possible to provide a high calcium intake rate in a small amount of the calcium powder.

More particularly, one embodiment of the present invention is a method of extracting calcium from organic fish waste including heating a liquid material, wherein the heating is operable to dissolve portions of the organic fish waste; adding the organic fish waste to the heated liquid material; stirring the organic fish waste with the heated liquid material to form a mixture of solid and liquid sediments; separating the solid sediments from the liquid sediments; sterilizing the solid sediments; and drying the solid sediments, wherein the drying removes moisture from the solid sediments.

In one embodiment, the organic fish waste comprises anchovy waste. In one embodiment, the liquid material comprises water. The embodiments include the above and wherein the liquid material is heated between 70 to 80 degrees Celsius.

In one embodiment of the present invention the separating is performed by centrifuging said mixture. According to one embodiment of the present invention, the separating is performed by settling and filtering the mixture.

In one embodiment of the present invention, the sterilizing comprises steam sterilizing the separated solid sediments between 150 and 200 degree Celsius for at least 15 minutes. According to one embodiment of the present invention, the drying method is selected from a group consisting of natural drying, freeze drying and hot air drying.

The embodiments include the above and wherein the method further includes pulverizing the dried solid sediments into a powder form. In one embodiment of the present invention the method further includes forming the powder form into a tablet form. In one embodiment, the method further includes packaging the powder form.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a schematic view showing the procedures to extract highly condensed calcium powder according with one embodiment of the present invention.

FIG. 2 is a cross-sectional view of a centrifuge usable in accordance with one embodiment of the present invention.

FIG. 3 shows the result of the assay of mineral ingredients contained in the calcium powder prepared according to one embodiment of the present invention.

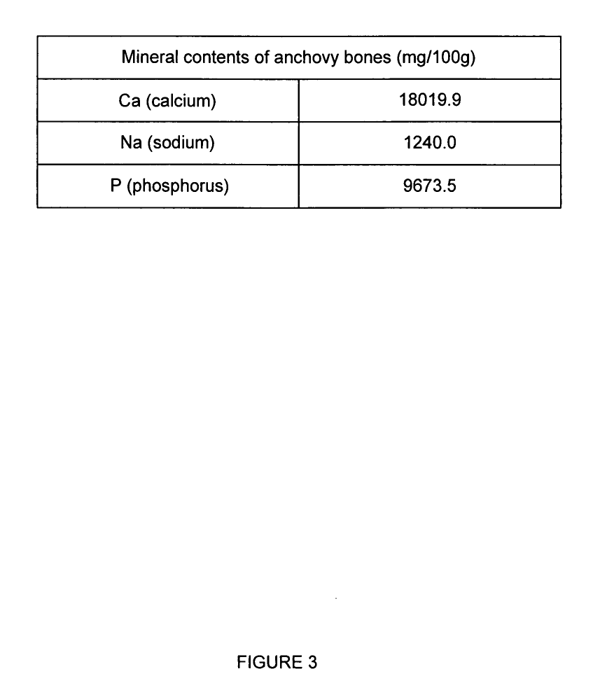

### DETAILED DESCRIPTION

Reference will now be made in detail to embodiments of the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details. In other instances, well known methods, procedures, components, and circuits have not been described in detail as not to unnecessarily obscure aspects of the invention.

### Method for Extracting Highly Condensed Calcium Powder from Salted Anchovies and the Highly Condensed Calcium Powder Obtained Therefrom

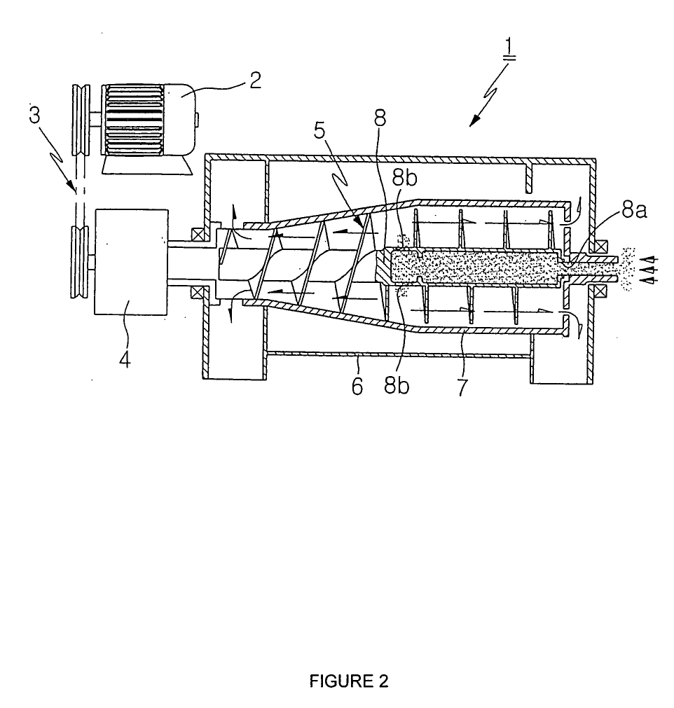

According to an embodiment of the present invention, salted anchovies which have been prepared by mixing 75 wt % of washed anchovies with 25 wt % of purified salt, followed by fermenting and ripening at room temperature for 1 to 3 years are separated into the sauce and the sediments using a centrifuge 1 shown in FIG. 2. In one embodiment, the sediments discharged from the centrifuge 1 are mixed with warm water at a temperature of 70 to 80° C. in a weight ratio of 5:5 and the mixture is charged into a stirrer. The stirred mixture of the sediments and warm water is charged again into the centrifuge 1 to separate the solid phase mainly comprising anchovy bones and the liquid phase comprising skin, flesh and oily components dissolved therein. The solid phase is introduced into a common steam sterilizer set to an inside temperature of 150 to 230° C. for instance and kept for 15 minutes in one example. The sterilized solid product is dried and pulverized into powder. The powder is packaged into a various containers or used as it is for the purpose. Here, the drying method includes natural drying at room temperature or freeze drying and hot air drying using an additional dryer, which may be selected by the operator who has ordinary knowledge in this art.

Also, instead of the separation of the sauce and the sediments from the salted anchovies by using the centrifuge 1, other well known separation methods such as settling and filtration may be used to separate the sauce and the sediments.

The centrifuge 1, as shown in FIG. 2, comprises a casing 6, a cylindrical shaped inner tank 7 disposed in the casing 6 and a screw conveyer 5 rotatably disposed in the inner tank 7 and axially aligned with a reduction gear 4 connected to a driving motor 2 via a power transmission means 3a belt and a belt pulley. An inlet 8a is provided at one side of a central axis 8 of the screw conveyer 5 and a through-hole 8b is provided at middle of the central axis 8 so that the object to be centrifuged is supplied to the inner tank 7. The object introduced through the inlet 8a is passed the through-hole 8b and supplied to the inner tank 7, in which the solid material such as sediments is transferred to the top end by the screw conveyer 5 and the sauce and the liquid phase are separately collected at the other side. It is appreciated that any of a number of well known centrifuges may be used and the above description is merely exemplary.

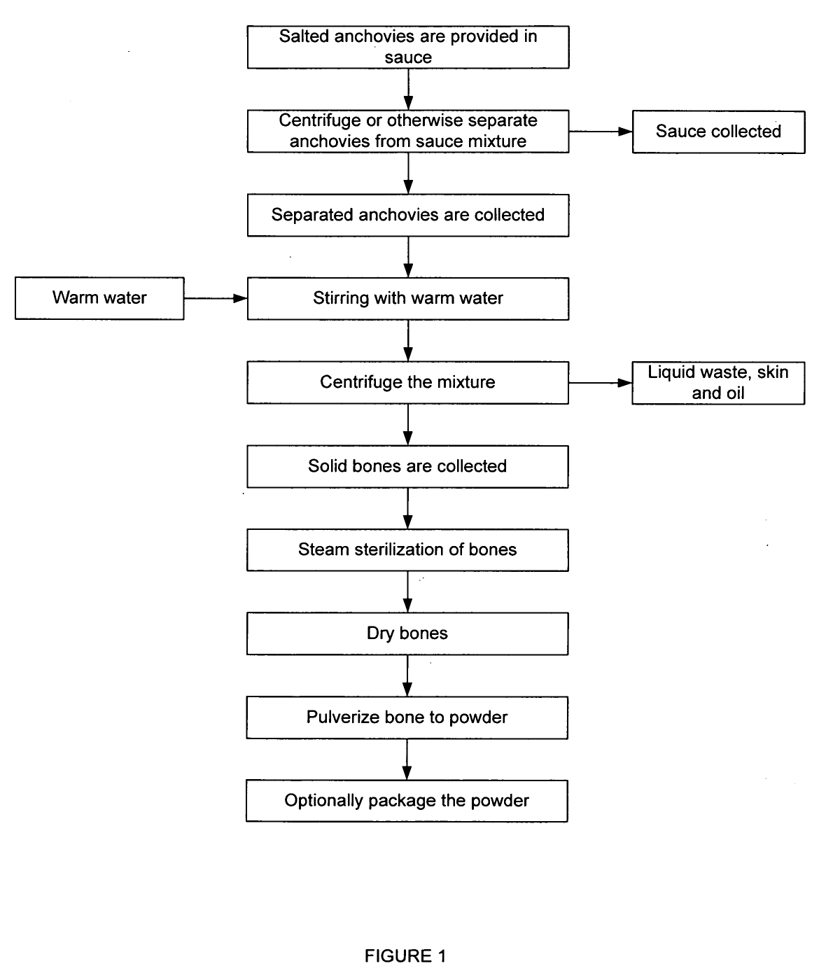

Now, the construction of one embodiment of the present invention as described above will be explained with reference to the procedures shown in FIG. 1. One method for extracting highly condensed calcium powder from salted anchovies according to the present invention comprises the following steps.

In the first step, salted anchovies are provided which have been fermented and ripened for 1 year at a room temperature.

In, the second step, the salted anchovies are introduced into an inlet 8a at a central axis 8 of a screw conveyer 5 in a centrifuge 1. Upon the operation of the centrifuge 1, the salted anchovies are supplied to the inner tank 7 through opening 8b, in which the sediments are separated and transferred by the rotating screw conveyer 5 to the top end and the sauce is separately collected by centrifugation.

Here, instead of the separation of the sauce and the sediments from the salted anchovies by using the centrifuge, the sediments may be separated from the sauce by the common settling and filtration processes. The separated sauce is supplied to an additional packaging apparatus for shipment.

In the third step, the sediments are introduced into a stirrer with warm water at a temperature of 70 to 80° C. for example in a weight ratio of 5:5 for example, followed by sufficient stirring.

In the fourth step, the stirred mixture of the sediments and warm water is introduced to a centrifuge 1 to separate the solid phase comprising mainly anchovy bones and the liquid phase comprising skin, flesh and oily components of anchovies dissolved therein.

In the fifth step, the liquid phase may be thrown away as sewage or be produced into a compost and the solid phase is introduced in a steam sterilizer at a temperature of 150 to 200° C. for instance and kept there for 15 minutes for sterilization and pasteurization.

In the sixth step, the steam sterilized solid product is dried by one selected from natural drying, freeze drying and hot air drying to remove moisture.

In the seventh step, the dried solid is pulverized into powder. Here, the powder has a particle size as large as particles of flour but it is not particularly limited since it may vary according to the purpose and functions.

In the eighth step, the pulverized powder may be packaged in a container or used for other purposes. The powder may be used as it is in the form of calcium formulates and calcium supplements or added to prepare food or drugs for calcium reinforcement. Also, it may be internally used in the form of pills or solutions.

In one embodiment, the powder is obtained by pulverizing the solid product comprising mainly anchovy bones and we requested Food engineering laboratory in Gyeongsang National University to conduct assay of mineral components contained in the solid product and obtained the result as follows.

TABLE 1
Mineral contents of anchovy bones (mg/100 g)

| | |
|---|---|
| Ca (calcium) | 18019.9 |
| Na (sodium) | 1240.0 |
| P (phosphorus) | 9673.5 |

The assay of mineral components contained in the solid product (anchovy bones) was performed by I.C.P (Atomatic Absorption Spectrophotometer). Commonly, 10 g of anchovy contains about 500 mg of calcium, while the solid product obtained by the extraction method according to the present invention contains 18019.9 mg of calcium per 100 g, which is as much as about 36 times. Thus, if 10 g of the calcium powder prepared according to one embodiment of the present invention is taken, it can provide the same effect of taking 3600 g of anchovies, though the calcium powder comprises Na or P and proteins in addition to calcium. In other words, it is noted that the calcium powder according to one embodiment of the present invention contains the calcium component at a highly condensed level.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method of extracting calcium comprising:
adding organic fish to heated liquid material, wherein said heated liquid material is operable to dissolve portions of said organic fish;
stirring said organic fish with said heated liquid material to form a mixture of solid and liquid sediments;
separating said solid sediments from said liquid sediments;
sterilizing said solid sediments; and
drying said solid sediments, wherein said drying removes moisture from said solid sediments, and wherein said solid sediments are high in Calcium.

2. The method as described in claim 1, wherein said organic fish comprises anchovy waste from prior fermentation, and wherein said solid sediments comprise fish bone.

3. The method as described in claim 1, wherein said liquid material comprises water.

4. The method as described in claim 1, wherein said liquid material is heated between 70 to 80 degrees Celsius.

5. The method as described in claim 1, wherein said separating is performed by centrifuging said mixture.

6. The method as described in claim 1, wherein said separating is performed by settling and filtering said mixture.

7. The method as described in claim 1, wherein said sterilizing comprises steam sterilizing said separated solid sediments between 150 and 230 degree Celsius for at least 15 minutes.

8. The method as described in claim 1, wherein said drying is selected from a group consisting of natural drying, freeze drying and hot air drying.

9. The method as described in claim 1 further comprising:
pulverizing said dried solid sediments into a powder form.

10. The method as described in claim 9 further comprising:
forming said powder into a tablet form.

11. The method as described in claim 9 further comprising:
packaging said powder form.

12. A system for extracting calcium from organic fish comprising:
a heater for heating liquid material;
a mixer operable to mix said organic fish with said heated liquid material, wherein said heated liquid material is operable to dissolve portions of said organic fish, and wherein said mixer forms a mixture of solid and liquid sediments;
a centrifuge for separating said solid sediments from said liquid sediments;
a sterilizer for sterilizing said solid sediments; and
a dryer for drying said solid sediments, wherein said drying removes moisture from said solid sediments, and wherein further said solid sediments are high in Calcium.

13. The system as described in claim 12, wherein said organic fish comprises anchovy waste from prior fermentation and wherein further said solid sediments comprise fish bone.

14. The system as described in claim 12, wherein said liquid material comprises water.

15. The system as described in claim 12, wherein said liquid material is heated between 70 to 80 degrees Celsius.

16. The system as described in claim 12, wherein said sterilizer is a steam sterilizer operable to heat said separated solid sediments between 150 and 230 degree Celsius for at least 15 minutes.

17. The system as described in claim 12, wherein said dryer is a freeze dryer.

18. The system as described in claim 12, wherein said dryer is a hot air dryer.

19. The system as described in claim 12 further comprising:
a pulverizer for forming said dried solid sediments into a powder form.

20. A system for extracting calcium from organic fish comprising:
a heater for heating liquid material;
a mixer operable to mix said organic fish with said heated liquid material, wherein said heated liquid material is operable to dissolve portions of said organic fish, and wherein said mixer forms a mixture of solid and liquid sediments;
at least one filter for separating said solid sediments from said liquid sediments;
a sterilizer for sterilizing said solid sediments; and
a dryer for drying said solid sediments, wherein said drying removes moisture from said solid sediments, and wherein said solid sediments are high in Calcium.

21. The system as described in claim 20, wherein said organic fish comprises anchovy waste from prior fermentation, and wherein further said solid sediments comprise fish bone.

22. The system as described in claim 20, wherein said liquid material comprises water.

23. The system as described in claim 20, wherein said liquid material is heated between 70 to 80 degrees Celsius.

24. The system as described in claim 20, wherein said sterilizer is a steam sterilizer operable to heat said separated solid sediments between 150 and 230 degree Celsius for at least 15 minutes.

25. The system as described in claim 20, wherein said dryer is a freeze dryer.

26. The system as described in claim 20, wherein said dryer is a hot air dryer.

27. The system as described in claim 20 further comprising:
a pulverizer for forming said dried solid sediments into a powder form.
